(19) United States
(12) Patent Application Publication
(10) Pub. No.: US 2014/0174222 A1
(43) Pub. Date: Jun. 26, 2014

(54) BALL SCREW WITH CENTRAL PROTRUSION

(71) Applicant: ThyssenKrupp Presta AG, Eschen (LI)

(72) Inventors: Alexander Kiforiuk, Ebersbach An Der Fils (DE); Dennis Kontner, Goppingen (DE); Frank Birkwald, Ostfildern (DE)

(73) Assignee: THYSSENKRUPP PRESTA AG, Eschen (LI)

(21) Appl. No.: 14/105,784

(22) Filed: Dec. 13, 2013

(30) Foreign Application Priority Data
Dec. 14, 2012 (DE) 102012024416.9

(51) Int. Cl. B62D 3/08; F16H 25/22

(52) U.S. Cl. CPC B62D 3/08; F16H 25/22
USPC 74/89.23

(57) ABSTRACT

The invention relates to a power-steering system with a bail screw drive, having a threaded spindle (10) and a ball nut, which are connected together in a movable manner by means of balls (14) arranged in the respective threads. A flank diameter of the thread (11) of the threaded spindle (10) is designed to be variable over the length of the threaded spindle (10).

The present invention relates to a power-steering system with a ball screw drive according to the generic part of independent claim 1.

To assist with the steering of a motor vehicle, the steering system may be provided with power assistance. Such steering devices are referred to as electric power or electric power assisted steering (EMS). In power-steering systems with a ball screw drive this will comprise at least a threaded spindle, on which a ball nut is arranged. The threaded spindle and ball nut each have a thread essentially describing a partial circle, in the thread a plurality of balls are provided, via which the threaded spindle and the bail nut are mechanically coupled. By twisting the ball nut the threaded rod can be displaced laterally. The twisting of the bail nut is initiated by a steering movement of a driver in the vehicle.

The ball screw drive is subject to the usual mechanical stresses during operation, which can lead to annoying rattling noises. So normally measures are taken in order to reduce the noises to a minimum. In particular in ball screw drives the threaded spindle is normally pre-stressed, but this can have negative effects on the service life and the steering haptics. In addition, such stressing leads to uneven wear. As a result of the stressing the threaded spindle can become bent, axially displaced or angled, as a result of which the threaded spindle is forced against the components, above all the ball nut, which is where the rattling noises occur.

In order to exclude these disadvantages a problem for the present invention, is to further develop a power-steering system of the kind mentioned above in which the threaded spindle does not need to axially displace, bend or become angled.

A power-steering system to solve the problem for the invention has the features of independent claim 1. According to this a power-steering system is provided, with a ball screw drive, having a threaded spindle and a ball nut, arranged thereon in a movable manner, wherein the threaded spindle and the ball nut each have as thread for partial acceptance of balls, joining the threaded spindle to the ball nut, wherein the thread over a length of the threaded spindle has a variable height. As a result of the variable height of the thread the balls protrude at varying heights from the thread, as a result of which a variation in the play acting between the threaded spindle and the ball nut is brought about. With the variable play an over the length of the threaded spindle the rattling noises can be avoided for certain steering positions.

According to a preferred embodiment it can be provided that the height of the thread at a centre of the threaded spindle, corresponding to a neutral position of the power-steering system, is lower than in the end areas of the thread, wherein the height in the end areas is gradually variable from the centre to the respective ends of the threaded spindle, in particular increasing. The neutral position of the power-steering system corresponds to driving straight ahead in a motor vehicle in which the power-steering system is installed. Thus the steered wheels essentially remain in a longitudinal direction of the motor vehicle. In this neutral position the stress on the ball screw drive is at its lowest, for which reason in this position the lowest play can also be envisaged. In the case of a full steering lock, when therefore the ball nut is positioned at one or other end of the threaded spindle, a high stress can be expected, for which reason there can be greater play here.

According to a further advantageous configuration the height of the thread at the ends of the threaded spindle can correspond to approximately a half ball diameter. The ends with the half bail diameter correspond here to a thread size that is normal for ball screw drives.

If the thread of the threaded spindle is designed in this way, it can be provided that the balls in particular at the ends are arranged to approximately half of their ball volume in the thread and in the centre are arranged to less than half of this in the thread. By arranging the balls in the centre to less than half their ball volume the balls protrude higher from the thread than at the ends, so that the play between threaded rod and ball nut in the centre of the threaded spindle is less than at the ends.

According to a development of the invention the centre of the thread of the threaded spindle can correspond to at least one thread turn, preferably a length of the corresponding thread of the ball nut, with the end areas extending between the centre and the respective ends. The thread has a mirror-image design, wherein the centre of the thread with the same thread height can extend over several thread turns, which preferably corresponds to the length of the ball. In this way all balls in the centre are held consistently in the respective threads, as a result of which the play is the same over the entire length of the ball nut.

Furthermore, according to a further configuration it can be provided that towards the respective ends of the threaded spindle the thread height increases. In this way the play over the course of the threaded spindle towards the ends is increased by contrast to the centre, as a result of which the wear in this area can be reduced.

In order for the rattling noises to be avoided as far as possible, it can be provided that a minimal play between the threaded spindle and the ball nut corresponds to zero in the centre of the threaded spindle. If no play is provided for between the components, neither can these knock against each other so that no noise is produced.

Similar provision can be made according to an aspect after the invention if a maximum play in the centre of the threaded spindle is greater than a minimum play in the end areas. This guarantees that in the end areas also only very little play can occur. The play over the entire length of the threaded spindle and the play at each individual section of the threaded spindle can vary, so that the play in the centre also lies between and a minimum and a maximum. The play of each individual section is selected such that it falls within narrow limits, whereby the maximum play in the centre does not exceed a minimum play in the play in the end areas.

The power-steering system can be constructed in such a way that a difference between the minimum and the maximum play in the area of the centre is smaller than in the end areas. In particular when driving straight ahead, which is the way in which a motor vehicle is mainly driven, the rattling noises will be reduced to a minimum, which is why the play in the centre has narrower limit settings, than in the end areas, where furthermore the stress is greater and thus also a danger of damage can be minimised.

According to an advantageous development of the invention, the lead angle of the thread can be variable over the length of the threaded spindle, in particular being larger at the ends than in the centre. As the thread diameter expands the lead angle also increases, and this takes place gradually from the centre to the ends.

According to a further preferred embodiment it can be provided that a flank angle can be variable over the length of the threaded spindle, in particular being smaller at the ends than in the centre. By means of the flank angle a rolling track for the balls of the ball screw drive on the threaded spindle can be described, wherein with a large angle the balls protrude further from the bail track than with a small angle.

Further advantageous configurations of the invention from part of the subclaims.

In the following a preferred embodiment is described in more detail using the drawing. This shows as follows:

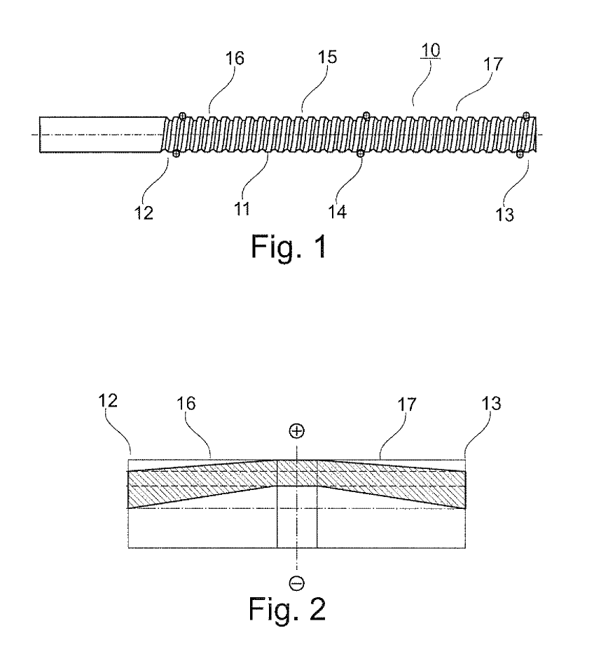

FIG. 1 a side view of a threaded spindle

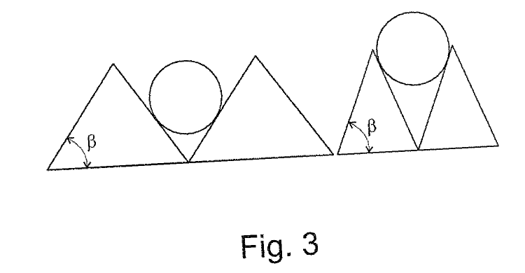

FIG. 2 a rollover diagram according to the threaded spindle after FIG. 1 with areas of differing play and

FIG. 3 a schematic representation of different partial circles of the threaded spindle.

A threaded spindle 10 is shown in FIG. 1 with what at first sight appears to be a normal thread 11 (corresponds to one thread turn), running from a first end 12 to a second end 13. The threaded spindle 10 is part of a ball screw drive, which for example can be installed in a power-steering system. Not shown in FIG. 1 is a ball nut, which is normally arranged on the threaded spindle 10 and also has a thread, corresponding to the thread 11 of the threaded spindle 10. The two threads 11 are designed to accommodate balls 14, for which reason they are essentially partially circular in shape.

The thread 11 with the partially circular shape varies over the length of the threaded spindle 10, such that the ends 12, 13 have a different thread height than the thread 11 approximately in the centre 15 of the threaded spindle 10. It is provided that the centre 15 is provided with a thread height which is smaller than the thread height at the two ends 12, 13. As a result of the smaller thread height in the centre, the balls protrude further from the thread, or which reason a minimum play envisaged between the threaded spindle and the ball nut is smaller than at the ends 12, 13. As a result of this the rattling noises resulting from the play can be reduced.

The thread height is defined as the difference between a nominal diameter, thus an external diameter, and a core diameter. In other words, the difference is made up of the external diameter of the peripheral outer surface of the threaded spindle 10 and a greatest thread depth of the thread 11. Due to the variable thread height a flank angle β also varies. The flank angle β can be defined as a measure of a rolling track of the balls 14, wherein due to a different flank angle β the balls protrude from threaded spindle 10 to differing extents.

In the centre 15 the threaded spindle 10, which can also be referred to as a threaded rod or threaded steering rack, accordingly has a central protrusion. The central protrusion relates to the threaded spindle 10, which in this embodiment in the centre 15 has a larger core diameter than at the ends 12, 13. Sections extend between each of the ends 12, 13 and the centre 15 which are referred to as end areas 16, 17. The end areas 16, 17 similarly have a greater thread height than the centre 15 of the thread 11. In the end areas 16, 17 the core diameter of the threaded spindle 10 narrows continuously from the centre 15 towards the ends 12, 13, as a result of which the thread height varies in end areas 15, 17. Due to the central protrusion the balls 14 protrude further from the threaded spindle 10 than in the end areas 16, 17. A diameter D of a ball track, the mean distance between two balls at 180° to each other, is thus in the centre greater by the amount of the central protrusion than in the end areas 16, 17.

The central protrusion or the thread height is designed to be constant in the centre 15. Here for example the lowest thread height can correspond to a length of a thread turn. It is preferred, however, that the thread height is constant over a length that corresponds to the length of the ball nut, in particular the length of the corresponding thread of the ball nut. If for example the bail nut has a thread with 4 or 5 thread turns, the length of the centre 15 with a constant thread height similarly corresponds to a length of 4 or 5 thread turns. This ensures the same amount of play in the centre 15 of the threaded spindle 10 over the entire length of the ball nut.

The play between the threaded spindle 10 and the ball nut in the centre 15 has a minimum of zero and a maximum of a value that is greater than a minimum play in the end areas 16, 17 and the ends 12, 13. The play is shown in the rollover diagram of FIG. 2. The rollover diagram shows the play that occurs in each area between the threaded spindle as a result of the differing thread height and the ball nut that is not shown. The rollover diagram also shows a central measuring area which in the central position is calibrated at 0 μm. The area of the centre 15 is shown in FIG. 2 as area I, whereas the end areas 16, 17 of the threaded spindle correspond to the areas marked II.

It is similarly evident from the rollover diagram that a difference between minimum and maximum play in the end areas 16, 17 gradually increases from the centre 15 to the ends 12, 13, for which reason when driving straight ahead the difference is smaller. The difference is greatest at a maximum travel, if therefore the ball nut comes up against the ends 12, 13 of the threaded spindle 10 and a maximum steering lock is brought about with the power-steering system. In the rollover diagram the steering lock of the power-steering system is identified as part of a functional area, which is why the steering lock is identified to the left and to the right in each case as half a functional area.

Due to the different thread height over the longitudinal extension of the threaded spindle 10 a lead angle of the thread also varies. The lead angle α of a thread is normally calculated with the arctangent arctan of Pitch/(Flank diameter*Pi). The pitch is defined as the path which is travelled by one rotation of the thread turn. In other words therefore the distance between two thread tips. The flank diameter, defined as the distance between two opposing thread flanks, is replaced by a partial circle in the invention. The partial circle corresponds to the extent of the partially circular thread 11.

[symbol]

α=arctan [symbol] [symbol] (Steigung/(π*Teilkreis)

[symbol]

[symbol]

α=arctan [symbol] [symbol] (Steigung/(π*Teilkreis) [symbol] ) (f1)

Steigung=Pitch

Teilkreis=Partial circle

The larger partial circle in the end areas also results in a greater lead angle α1 there than in the centre where the lead angle α2 is smaller.

FIG. 3 illustrates the effect of a change in the flank angle β over the length of the threaded spindle. The flank angle is measured against the longitudinal axis of the threaded spindle, if the flank angle is increased, the partial circle diameter of the thread also increases. As a result the play between ball nut and threaded spindle is reduced. With a smaller flank angle, on the other hand, the play is reduced. A screw drive according to the invention can therefore be obtained without increasing the core diameter in the central area, if in the central area the flank angle β is increased compared with the end areas.

1. A power-steering system ball screw drive, including:
a threaded spindle; and
a ball nut arranged on the threaded spindle in a movable manner,
wherein the threaded spindle and the ball nut each have a thread for partial acceptance of balls, joining the threaded spindle to the ball nut, and wherein the thread has a variable height over a length of the threaded spindle.

2. The power-steering system ball screw drive according to claim 1, wherein the height of the thread at a centre of the threaded spindle, corresponding to a neutral position of the power-steering system, is lower than in end areas of the thread, wherein the height in the end areas is gradually variable from the centre to the respective ends of the threaded spindle.

3. The power-steering system ball screw drive according to claim 1, wherein the height of the thread at ends of the threaded spindle corresponds to approximately a half ball diameter.

4. The power-steering system ball screw drive according to claim 1, wherein the thread of the threaded spindle is designed in such a way that the balls at ends of the threaded spindle are arranged to approximately half of their ball volume in the thread and in the centre are arranged to less than half of their ball volume in the thread.

5. The power-steering system ball screw drive according to claim 1, wherein a centre of the thread of the threaded spindle corresponds to at least one thread turn.

6. The power-steering system ball screw drive according to claim 1, wherein a minimum play between threaded spindle and the ball nut in a centre of the threaded spindle corresponds to zero.

7. The power-steering system ball screw drive according to claim 1, wherein a maximum play in a centre of the threaded spindle is greater than a minimum play in end areas of the threaded spindle.

8. The power-steering system ball screw drive according to claim 1, wherein a difference between minimum and maximum play in the area of a centre of the threaded spindle is smaller than in end areas of the threaded spindle.

9. The power-steering system ball screw drive according to claim 1, wherein a lead angle of the thread of the threaded spindle is variable over a length of the threaded spindle, and is greater at ends of the threaded spindle than in a centre of the threaded spindle.

10. The power-steering system ball screw drive according to claim 1, wherein a flank angle β varies over a length of the threaded spindle and is smaller at ends of the threaded spindle than in a centre of the threaded spindle.

11. The power-steering system ball screw drive according to claim 10, wherein for a constant core and/or head diameter over a length of the threaded spindle, a partial circle is varied by means of a variation in the flank angle β.
